(19) United States
(12) Patent Application Publication
(10) Pub. No.: US 2022/0283102 A1
(43) Pub. Date: Sep. 8, 2022

(54) METHOD OF ANALYZING STRUCTURE OF RESIN MATERIAL

(71) Applicant: MAZDA MOTOR CORPORATION, Hiroshima (JP)

(72) Inventors: Mitsuyoshi KAWABE, Aki-gun (JP); Daiji KATSURA, Aki-gun (JP); Tetsuya MAEDA, Aki-gun (JP)

(73) Assignee: MAZDA MOTOR CORPORATION, Hiroshima (JP)

(21) Appl. No.: 17/585,822

(22) Filed: Jan. 27, 2022

(30) Foreign Application Priority Data
Mar. 3, 2021 (JP) 2021-033582

(51) Int. Cl. G01N 23/046

(52) U.S. Cl. CPC G01N 23/046; G01N 2223/419; G01N 2223/60

(57) ABSTRACT

A structure analysis method includes impregnating a resin material with a radiosensitizer. The resin material contains thermoplastic resin. The radiosensitizer contains a solvent and a radiosensitizing molecule that contains, as a heavy element, an element with an atomic number equal to or greater than that of fluorine. A relative energy difference (RED₁) represented by Rₐ₁/R₀₁ is 1.8 or less in a case where R₀₁ is the interaction radius of the thermoplastic resin in a Hansen space and Rₐ₁ is a distance between the Hansen solubility parameters of the thermoplastic resin and the solvent.

### CROSS-REFERENCE TO RELATED APPLICATION

This application claims priority to Japanese Patent Application No. 2021-033582 filed on Mar. 3, 2021, the entire disclosure of which is incorporated by reference herein.

### BACKGROUND

The present disclosure relates to a method of analyzing the structure of a resin material using radiation.

Typically, radiation analysis apparatuses have been used to analyze the internal structures of various substances. For example, an X-ray computed tomography (CT) apparatus captures an image of an analyte in a cross section as follows. The analyte is irradiated with X-rays to make the intensity of X-ray transmittance, which varies depending on the material and/or density of the analyte, visible as the shade of the image. Such a radiation analysis apparatus has difficulty in analyzing, with a high sensitivity, a resin material with a lower density. To address the problem, there are suggested methods of analyzing the structure of a resin material as in Patent Documents 1 and 2.

Japanese Unexamined Patent Publication No. 2019-112612 relates to detection of a resin molded body using an X-ray inspection machine as follows. Barium sulfate containing barium, which is a relatively large atom, is kneaded with resin to obtain the resin molded body. This facilitates detection of the resin molded body using the X-ray inspection machine.

Japanese Unexamined Patent Publication No. 2012-233751 relates to a method of detecting a change in the internal structure of the resin molded body from an X-ray transmission image as follows. A resin X-ray contrast agent penetrates the resin molded body to detect a change in the internal structure of the resin molded body based on a change in the penetration rate of the resin X-ray contrast agent, the resin X-ray contrast agent being made of a hydrocarbon-based compound with a mass absorption coefficient higher than that of the resin forming the resin molded body.

### SUMMARY

In recent years, resin materials have been diversified, and resin materials having a fine porous structure with a skeleton diameter of about micrometers to hundreds of micrometers have been used in various fields. The resin material with such a porous structure has not only a very small density but also very small thickness and diameter. The luminance histogram or noise of gas in pores thus overlaps the luminance histogram of solid in X-ray CT analysis. Separation (i.e., binarization) of these overlapping luminance histograms causes different results from analyst to analyst. For the resin with the porous structure, an image close to an actual resin structure is thus hardly obtained with a high resolution. While gradient improvement and a finer contrast are needed, typical radiosensitizers are hardly uniformly dispersed in a resin material and thus not advantageous in solving the problems described above.

The technique disclosed herein relates to a method of analyzing the structure of a resin material, in which radiosensitizing molecules containing heavy elements are highly dispersed in the resin material. Accordingly, an image close to an actual resin structure is obtainable with a sufficient resolution.

In order to solve the problems described above, the present disclosure focuses on relative energy differences in a Hansen solubility parameter between a radiosensitizing molecule and a solvent and between resin and the solvent.

Specifically, the technique disclosed herein relates to a method of analyzing the structure of a resin material using radiation.

The method includes impregnating the resin material with a radiosensitizer.

The resin material contains thermoplastic resin.

The radiosensitizer contains a solvent and a radiosensitizing molecule that contains, as a heavy element, an element with an atomic number equal to or greater than that of fluorine.

A relative energy difference (RED₁) represented by Rₐ₁/R₀₁ is 1.8 or less in a case where R₀₁ is the interaction radius of the thermoplastic resin in a Hansen space and Rₐ₁ is a distance between the Hansen solubility parameters of the thermoplastic resin and the solvent.

According to this configuration, the radiosensitizing molecule and the solvent are selected such that the relative energy difference (RED₁) in the Hansen solubility parameters between the thermoplastic resin and the solvent is a predetermined value. Accordingly, the heavy elements can be uniformly dispersed into the thermoplastic resin structure. Uniform dispersion of the heavy elements while the resin structure is maintained can provide an image close to an actual resin structure with a sufficient resolution.

Note that in one preferred embodiment, the relative energy difference (RED₁) between the thermoplastic resin and the solvent is 0.4 or less.

Selection of such a solvent for the thermoplastic resin can more reliably provide the image close to the actual resin structure.

In one more-preferred embodiment, a relative energy difference (RED₂) represented by Rₐ₂/R₀₂ is 1.0 or less in a case where R₀₂ is the interaction radius of the radiosensitizing molecule in the Hansen space and Rₐ₂ is a distance between the Hansen solubility parameters of the radiosensitizing molecule and the solvent.

A relative energy difference (RED₂) of 1.0 or less between the Hansen solubility parameters of the radiosensitizing molecule with the heavy element and the solvent allows high dispersion of the heavy element-containing radiosensitizing molecules, which are aggregated by themselves, in the solvent. Accordingly, the heavy elements can be more uniformly dispersed in the resin structure, which provides an image with a higher resolution.

In one preferred embodiment, the resin material is impregnated with the radiosensitizer set to a temperature equal to or higher than the glass transition point of the resin material.

The radiosensitizer set to the temperature equal to or higher than the glass transition point of the resin material can further improve the impregnation properties and dispersibility of the heavy element-containing radiosensitizing molecule in the resin material.

In one preferred embodiment, the heavy element is an element with an atomic number equal to or greater than that of iodine.

The radiosensitizer with the molecules containing the elements with the atomic number equal to or greater than that of iodine can further improve the absorption and diffusion sensitivity of the radiation. Accordingly, the image close to the actual resin structure is more reliably obtainable with a sufficient resolution.

In one preferred embodiment, the resin material is a porous material including a fiber body, a foam body, or a composite of a fiber body and a foam body.

It is significant to apply the method of analyzing the structure of the resin material according to the present disclosure which can provide, with a sufficient resolution, an image close to an actual resin structure of a porous material, such as a fiber body or a foam body, which has been hardly analyzed in the related art. It is also possible to obtain an image of only a resin structure, which is to be selectively observed, of a composite of a fiber body and a foam body.

As described above, the present disclosure provides the method of analyzing the structure of the resin material, in which the radiosensitizing molecules containing the heavy elements are highly dispersed in the resin material. Accordingly, the image close to the actual resin structure is obtainable with a sufficient resolution.

### BRIEF DESCRIPTION OF THE DRAWINGS

FIG. 1 shows a flowchart for describing a structure analysis method of an embodiment.

FIG. 2 shows an X-ray CT image of a resin material of Example 1.

FIG. 3 shows an X-ray CT image of a resin material of Example 2.

FIG. 4 shows an X-ray CT image of a resin material of Example 3.

FIG. 5 shows an X-ray CT image of a resin material of Example 4.

FIG. 6 shows X-ray CT images of resin materials of Example 5 and Comparative Example 1.

FIG. 7 shows an X-ray CT image of a resin material of Example 6.

FIG. 8 shows a table of results of Examples 1 to 6 and Comparative Example 1.

FIG. 9 shows a graph of a preferred range of a relative energy difference (RED₁).

### DETAILED DESCRIPTION

Hereinafter, an embodiment of the present disclosure will be described. The following description of the preferred embodiment is merely an example in nature, and is not intended to limit the scope, applications, or use of the present disclosure.

The present embodiment provides a method of analyzing the structure of a resin material using radiation. The resin material includes thermoplastic resin. A radiosensitizer contains a solvent and radiosensitizing molecules that contain, as heavy elements, elements with an atomic number equal to or greater than that of fluorine.

[Analyte]

—Resin Material—

In the method of analyzing the structure of the resin material according to the present embodiment, the resin material to be analyzed contains the thermoplastic resin. Specific examples of the thermoplastic resin include: polyester-based resin, such as polyethylene terephthalate (PET) and polybutylene terephthalate; polyolefin-based resin, such as polyethylene, polypropylene (PP), and propylene-ethylene copolymer; polycarbonate-based resin; polyamide-based resin; and polyacrylic-based resin.

The thermoplastic resins may be used alone or in combination. In addition, the resin constituting the resin material is not limited only to the thermoplastic resin, and may include other resins such as thermosetting resin. The resin material may further contain components, such as an additive, in addition to the resin.

The form of the resin material is not particularly limited, but is a porous material including a fiber body, a foam body, or a composite of a fiber body and a foam body in one preferred embodiment. The fiber body includes nonwoven fabric. The foam body includes foam, such as polyurethane foam, and an injection foam molding material. The skeleton diameters of the fiber body and the foam body are not particularly limited. For example, the fiber body and the foam body may have a fine structure of micrometers to hundreds of micrometers.

—Radiosensitizer—

In the method of analyzing the structure of the resin material according to the present embodiment, the resin material described above is analyzed after being impregnated with the radiosensitizer. The radiosensitizer contains the radiosensitizing molecules and the solvent.

The radiosensitizing molecules contain, as the heavy elements, the elements with the atomic number equal to or greater than that of fluorine. An element with an atomic number equal to or greater than that of fluorine is believed to exhibit a greater radiosensitizing effect than an element having an atomic number smaller than that of fluorine. In particular, a halogen compound is known to exhibit a great radiosensitizing effect. The radiosensitizing molecules, into which the elements with the atomic number equal to or greater than that of fluorine have been introduced as the heavy elements, are dispersed in the resin material. This increases a difference in X-ray transmittance between the resin structure and a pore, which can provide a high-contrast image. The radiosensitizing molecules are not particularly limited. Examples include an iodine-containing compound such as triiodobenzene; a bromine-containing compound, a chlorine-containing compound, and a fluorine-containing compound. In one preferred embodiment, the heavy element is an element with an atomic number equal to or greater than that of iodine. Note that plural types of heavy elements may be combined and introduced into the radiosensitizing molecules.

The solvent is an organic solvent in which the radiosensitizing molecules are soluble. Examples of the solvent include toluene and THF. The type of solvent is selected depending on the type of radiosensitizing molecule to be dissolved and the type of resin material to be analyzed.

In the method of analyzing the structure of the resin material according to the present embodiment, an appropriate combination of the radiosensitizing molecules, the solvent, and the resin is selected depending on relative energy differences derived from Hansen solubility parameters.

—Hansen Solubility Parameters—

The Hansen Solubility Parameters (HSP) are an index of solubility showing the degree of solubility of a substance in another substance. HSP values can be calculated by a method described in Hansen Solubility Parameters, A User's Handbook, Charles M. Hansen (2007). The HSP (δ) includes three parameters (with a unit of MPa^{1/2}) of an energy (δd) from dispersion force between molecules, an energy (δp) from dipolar force between molecules, and an energy (δh) from hydrogen bonding between molecules. These three parameters are regarded as coordinates in a three-dimensional space called a “Hansen space,” and have a relationship of “δ²=(δD)²+(δP)²+(δH)².” The Hansen solubility parameters of two substances are placed in the Hansen space. At this point, the substances at a smaller distance in the Hansen solubility parameters are determined to be highly soluble.

The HSP of some commonly used substances is stored in a database. Referring to the database, the HSP of a desired substance may be obtained. For example, the Hansen solubility parameters (δd, δp, δh) of the solvent are as follows: toluene (18, 1.4, 2), THF (16.8, 5.7, 8), hexane (14.9, 0, 0), and ethanol (15.8, 8.8, 19.4). The HSP can be calculated using computer software (e.g., Hansen Solubility Parameters in Practice (HSPiP)).

Assume that the Hansen solubility parameters of the resin are (δ_{d1}, δₚ₁, δₕ₁), the Hansen solubility parameters of the solvent are (δ_{d2}, δₚ₂, δₕ₂), and Ra is a distance between the Hansen solubility parameters of the resin and the solvent in the Hansen space. In this case, the distance Ra of the Hansen solubility parameters can be calculated by Equation (1) below:

(Ra)²=4(δ_{d2}−δ_{d1})²+(δₚ₂−δₚ₁)²+(δₕ₂−δₕ₁)² (1)

Further, assume that the resin has the value of an interaction radius R₀ and a sphere with a radius R₀ about the Hansen solubility parameter coordinates of the resin is within the Hansen space. The relative energy difference (RED) is then represented by Rₐ/R₀. The resin is insoluble in the solvent in the case of RED>1, and is solvable in the case of RED<1.

In the method of analyzing the structure of the resin material according to the present embodiment, the resin material and the solvent are selected such that a relative energy difference (RED₁) represented by Rₐ₁/R₀₁ is 1.8 or less, in a case where R₀₁ is the interaction radius of the thermoplastic resin in the Hansen space and Rₐ₁ is a distance between the Hansen solubility parameters of the thermoplastic resin and the solvent. In one preferred embodiment, a combination of the thermoplastic resin and the solvent is selected such that the relative energy difference (RED₁) between the thermoplastic resin and the solvent is 0.4 or less.

In one preferred embodiment, a combination of the radiosensitizing molecules and the solvent is selected such that a relative energy difference (RED₂) represented by Rₐ₂/R₀₂ is 1.0 or less, in a case where R₀₂ is the interaction radius of the radiosensitizing molecules in the Hansen space and Rₐ₂ is a distance between the Hansen solubility parameters of the radiosensitizing molecules and the solvent.

[Structure Analysis Method]

—Analyzer—

The method of analyzing the structure of the resin material according to the present embodiment is performed by a three-dimensional structure analyzer using radiation, specifically, for example, an X-ray CT apparatus. The X-ray CT apparatus includes: at least an X-ray irradiator that irradiates an analyte with X-rays; and an X-ray detector that faces the X-ray irradiator with the analyte interposed therebetween and measures the X-rays transmitted through the analyte.

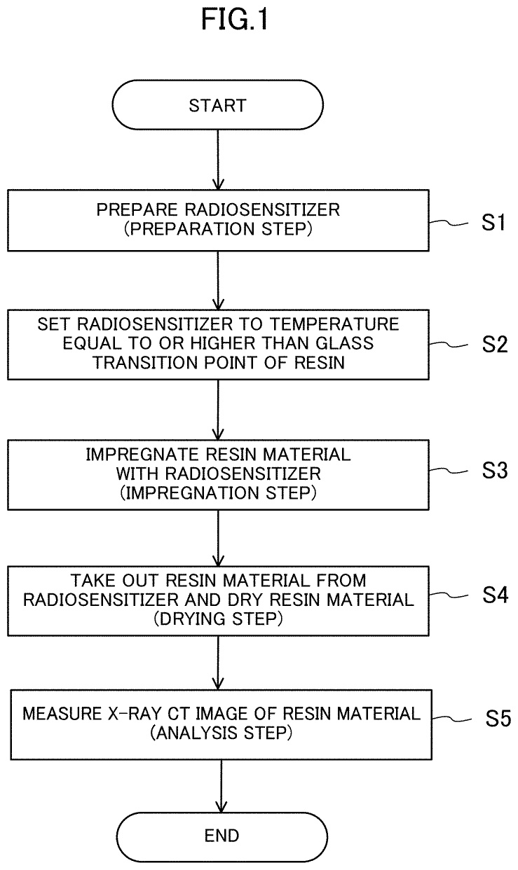

The method of analyzing the structure of the resin material according to the present embodiment is performed in the order shown in FIG. 1.

—Preparation Step—

First, an appropriate combination of the radiosensitizing molecules, the solvent, and the resin is selected considering the values of the relative energy differences (RED₁ and RED₂). Then, in a preparation step S1, the radiosensitizing molecules are dissolved into the solvent to prepare the radiosensitizer.

—Impregnation Step—

Next, the resin material is impregnated with the radiosensitizer. In this impregnation step, first, the radiosensitizer is set to a temperature equal to or higher than the glass transition point of the thermoplastic resin contained in the resin material (S2). In this state, the resin material is impregnated for a predetermined period of time (S3) in one preferred embodiment. For example, if polyethylene terephthalate is the thermoplastic resin contained in the resin material, the impregnation temperature is about 75° C. In the case of polypropylene, the impregnation temperature is about 25° C. After a lapse of the predetermined period of time, the resin material is cooled to room temperature, while being impregnated.

—Drying Step—

Next, in a drying step S4, the resin material is taken out of the radiosensitizer and dried under reduced pressure.

—Analysis Step—

Next, in an analysis step S5, the dried resin material is, as a sample, measured using the X-ray CT apparatus. The obtained data is analyzed to create a cross-sectional image, whose luminance histogram is binarized to separate the resin material into gas (pores) and a solid (resin), thereby grasping the structure of the resin material.

### Examples

In examples described in the present specification, 1,3,5-triiodobenzene was commonly used as the radiosensitizing molecules.

In Example 1, 30.4 mg of 1,3,5-triiodobenzene as the radiosensitizing molecules and 882 mg of toluene as the solvent were put into a glass container, and were heated at 75° C. for ten minutes to obtain a radiosensitizer solution. Polypropylene, which is a fiber resin with a porous structure (with a fiber size of 26 μm and a fiber length of 32 mm), was added as the resin material to the radiosensitizer, and was heated at 75° C. for 20 minutes. Next, the resin material and the radiosensitizer were cooled to room temperature. The resin material was then taken out of the radiosensitizer, and was dried under reduced pressure.

The resin material treated with the radiosensitizer in this manner was compared to an untreated resin material. For the purpose, each of the treated and untreated resin materials was packed into a straw-shaped support to prepare a sample. The two samples were bundled to be simultaneously measured with the X-ray CT apparatus (i.e., nano3DX manufactured by Rigaku Corporation). Note that the X-ray CT image was captured in a size of 1024×1024 pixels and 16 bit.

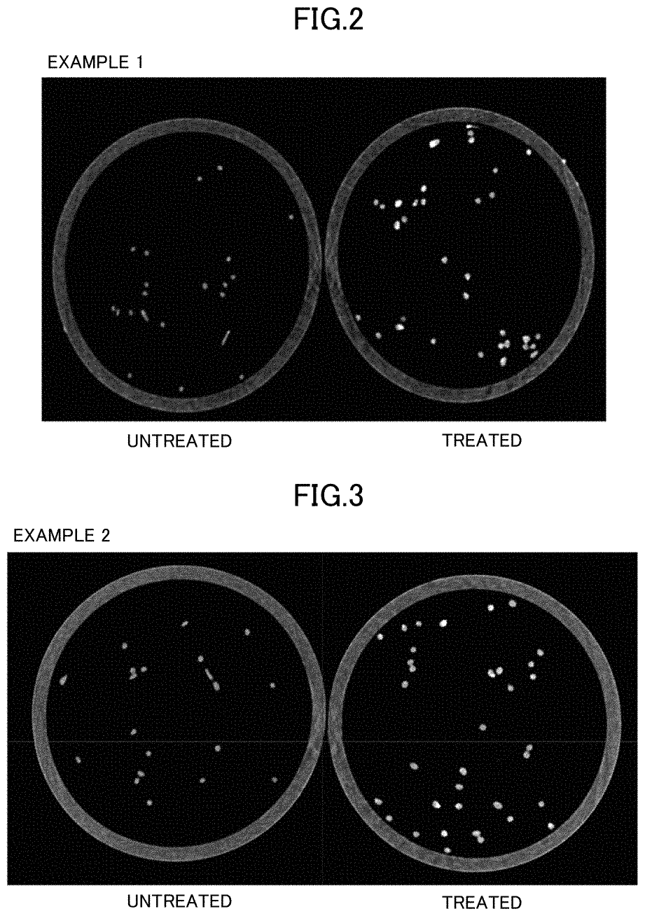

FIG. 2 shows a cross-sectional image of Example 1 captured by the X-ray CT apparatus. The image of “treated” polypropylene, which was treated with the radiosensitizer, had a higher contrast than that of “untreated” polypropylene. Such a difference could be also visually confirmed.

In addition, the average gradient of the cross-sectional image captured by the X-ray CT apparatus was calculated. A difference in the average gradient between the “treated” and “untreated” resin materials was obtained. With such a difference, whether or not the gradient was increased by treatment with the radiosensitizer as compared to the case without treatment was evaluated.

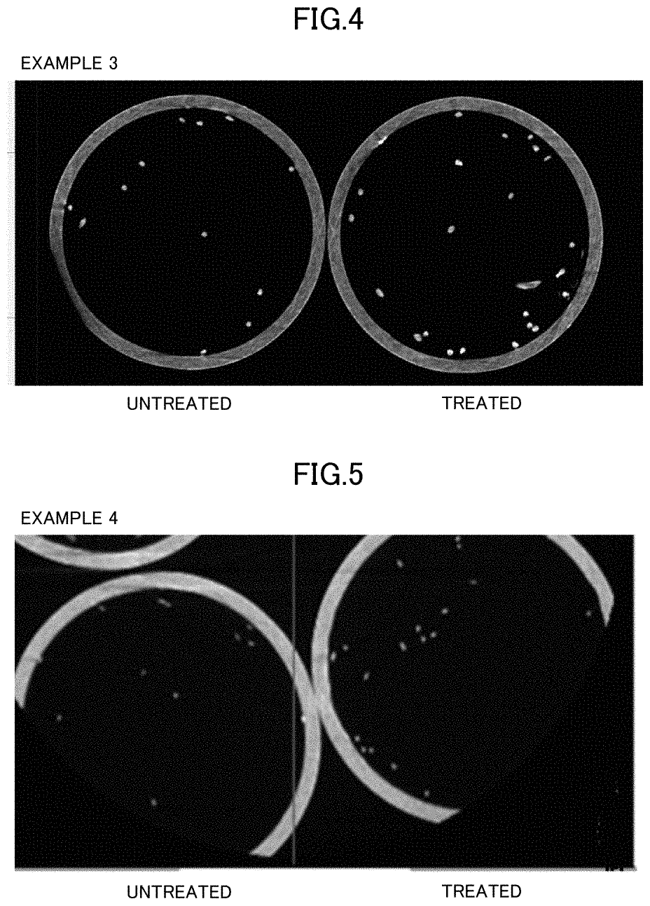

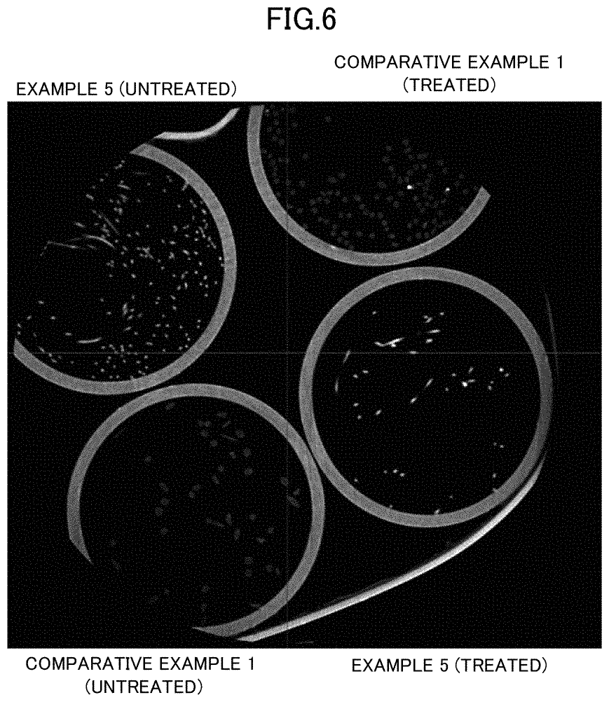

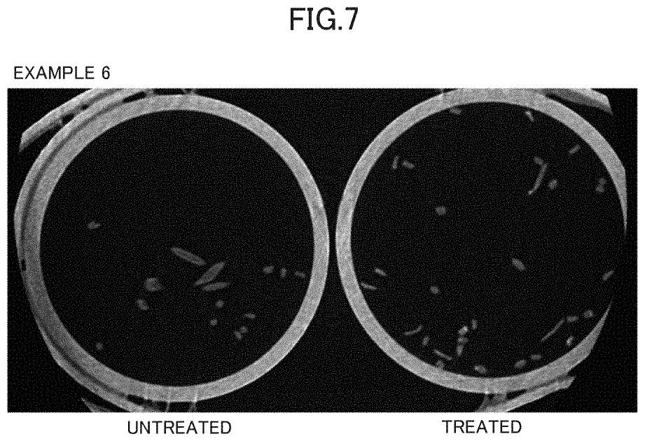

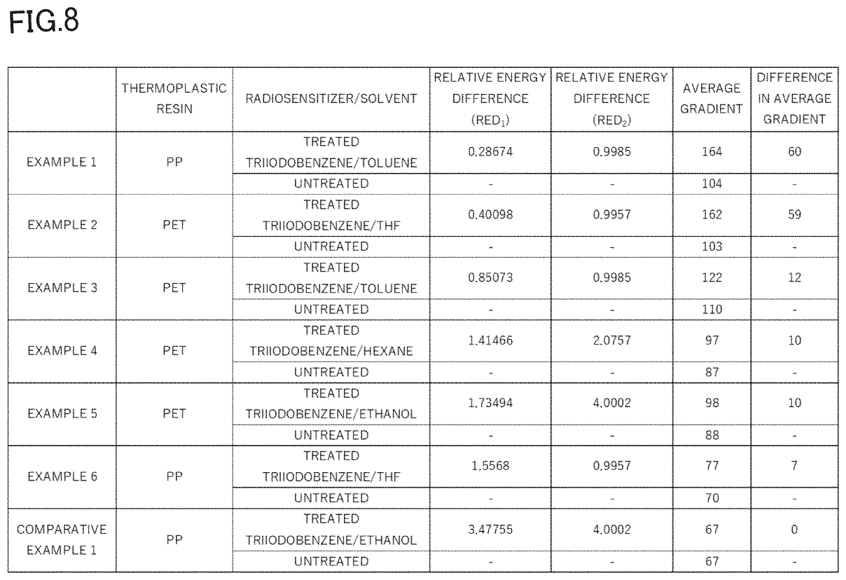

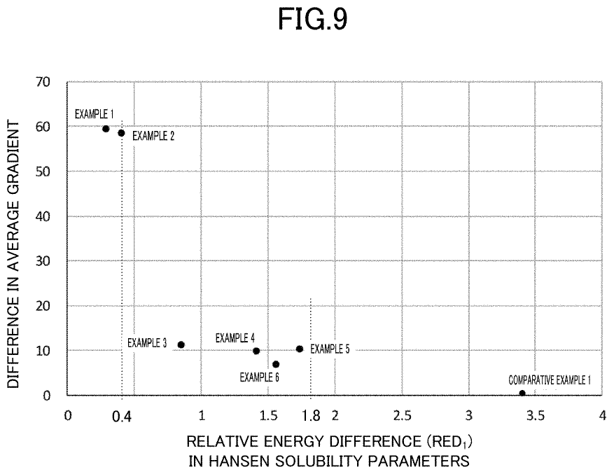

Next, in each of Examples 2 to 6 and Comparative Example 1, another combination of the thermosetting resin and the solvent was employed to obtain the X-ray CT images of the resin material treated with the radiosensitizer and the untreated resin material. The difference in the average gradient was obtained as in Example 1 to determine whether or not there was improvement in the gradient. FIGS. 3 to 7 show the cross-sectional images captured by the X-ray CT apparatus in Examples 2 to 6 and Comparative Example 1. In addition, FIG. 8 shows the combinations of the thermoplastic resin and the solvent in Examples 1 to 6 and Comparative Example 1. The obtained results are plotted as shown in FIG. 9. A preferred range of the relative energy difference (RED₁) is then shown.

In Comparative Example 1, the relative energy difference (RED′) in the Hansen solubility parameters between the thermoplastic resin and the solvent exceeds 1.8. In this example, the difference in the average gradient is 0, that is, no improvement in the CT image was found between the “treated” and “untreated” resins.

In each of Examples 1 to 6, the relative energy difference (RED₁) in the Hansen solubility parameters between the thermoplastic resin and the solvent is 1.8 or less. In each example, the “treated” resin has a higher average gradient than that of the “untreated” resin, that is, improvement in the CT image by the treatment with the radiosensitizer was found.

In addition, in Examples 1 and 2, the relative energy difference (RED₁) in the Hansen solubility parameters between the thermoplastic resin and the solvent is 0.4 or less, and the relative energy difference (RED₂) in the Hansen solubility parameters between the radiosensitizing molecules and the solvent is 1.0 or less. In each example, the “treated” resin has a higher average gradient than that of the “untreated” resin, that is, great improvement in the CT image by the treatment with the radiosensitizer was found.

What is claimed is:

1. A method of analyzing a structure of a resin material using radiation, the method comprising:
impregnating the resin material with a radiosensitizer,
the resin material containing thermoplastic resin, and
the radiosensitizer containing a solvent and a radiosensitizing molecule that contains, as a heavy element, an element with an atomic number equal to or greater than that of fluorine, and
a relative energy difference (RED₁) represented by Rₐ₁/R₀₁ being 1.8 or less in a case where R₀₁ is an interaction radius of the thermoplastic resin in a Hansen space and Rₐ₁ is a distance between Hansen solubility parameters of the thermoplastic resin and the solvent.

2. The method of claim 1, wherein
the relative energy difference (RED₁) between the thermoplastic resin and the solvent is 0.4 or less.

3. The method of claim 1, wherein
a relative energy difference (RED₂) represented by Rₐ₂/R₀₂ is 1.0 or less in a case where R₀₂ is an interaction radius of the radiosensitizing molecule in the Hansen space and Rₐ₂ is a distance between the Hansen solubility parameters of the radiosensitizing molecule and the solvent.

4. The method of claim 1, wherein
the resin material is impregnated with the radiosensitizer set to a temperature equal to or higher than a glass transition point of the resin material.

5. The method of claim 1, wherein
the heavy element is an element with an atomic number equal to or greater than that of iodine.

6. The method of claim 1, wherein
the resin material is a porous material including a fiber body, a foam body, or a composite of a fiber body and a foam body.

7. The method of claim 2, wherein
a relative energy difference (RED₂) represented by Rₐ₂/R₀₂ is 1.0 or less in a case where R₀₂ is an interaction radius of the radiosensitizing molecule in the Hansen space and Rₐ₂ is a distance between the Hansen solubility parameters of the radiosensitizing molecule and the solvent.

8. The method of claim 2, wherein
the resin material is impregnated with the radiosensitizer set to a temperature equal to or higher than a glass transition point of the resin material.

9. The method of claim 2, wherein
the heavy element is an element with an atomic number equal to or greater than that of iodine.

10. The method of claim 2, wherein
the resin material is a porous material including a fiber body, a foam body, or a composite of a fiber body and a foam body.

11. The method of claim 3, wherein
the resin material is impregnated with the radiosensitizer set to a temperature equal to or higher than a glass transition point of the resin material.

12. The method of claim 3, wherein
the heavy element is an element with an atomic number equal to or greater than that of iodine.

13. The method of claim 3, wherein
the resin material is a porous material including a fiber body, a foam body, or a composite of a fiber body and a foam body.

14. The method of claim 7, wherein
the resin material is impregnated with the radiosensitizer set to a temperature equal to or higher than a glass transition point of the resin material.

15. The method of claim 7, wherein
the heavy element is an element with an atomic number equal to or greater than that of iodine.

16. The method of claim 7, wherein
the resin material is a porous material including a fiber body, a foam body, or a composite of a fiber body and a foam body.
